(19) United States
(12) Patent Application Publication
(10) Pub. No.: US 2020/0311532 A1
(43) Pub. Date: Oct. 1, 2020

(54) LAMBDA-RESERVOIR COMPUTING

(71) Applicant: THE REGENTS OF THE UNIVERSITY OF CALIFORNIA, Oakland, CA (US)

(72) Inventors: Bahram Jalali, Los Angeles, CA (US); Tingyi Zhou, Los Angeles, CA (US); Cejo Konuparamban Lonappan, Los Angeles, CA (US)

(73) Assignee: THE REGENTS OF THE UNIVERSITY OF CALIFORNIA, Oakland, CA (US)

(21) Appl. No.: 16/835,993

(22) Filed: Mar. 31, 2020

Related U.S. Application Data
(60) Provisional application No. 62/827,796, filed on Apr. 1, 2019.

(51) Int. Cl. G06N 3/067; G06N 20/00; G06K 9/62

(52) U.S. Cl. CPC G06N 3/067; G06K 9/6267; G06N 20/00

(57) ABSTRACT

A Lambda reservoir computing system that can readily handle shifts in the distribution of input and output data. Data is modulated onto the spectrum of a broadband optical pulse which is subjected to nonlinear optical effects transforming the data to a higher optical dimensional space. The optical information is converted to electronic signals for processing by an electronic machine learning stage which then generates an output based on the data processed by the learning stage.

### CROSS-REFERENCE TO RELATED APPLICATIONS

This application claims priority to, and the benefit of, U.S. provisional patent application Ser. No. 62/827,796 filed on Apr. 1, 2019, incorporated herein by reference in its entirety.

### STATEMENT REGARDING FEDERALLY SPONSORED RESEARCH OR DEVELOPMENT

This invention was made with government support under Grant Number N00014-16-1-2237, awarded by the U.S. Navy, Office of Naval Research. This invention was also made with government support under Grant Number HR0011-19-9-0050, awarded by the Defense Advanced Research Projects Agency. The government has certain rights in the invention.

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to reservoir computing artificial intelligence systems, and more particularly to a Spectral Reservoir Computer providing a high dimensional dynamic reservoir.

### 2. Background Discussion

Artificial intelligence and in particular deep learning networks (DNN) and recurrent neural networks (RNN) are revolutionizing computer vision and natural language processing (NLP) and are appearing in an increasing number of consumer and industrial applications. These networks are first trained offline on a GPU or high-performance CPU cluster for anywhere from tens of hours to a few weeks. The network is then deployed into the application where it takes in a continuous stream of input data and runs inference in real time. The outputs are either directly used as the end result or further fed into downstream systems to produce the desired response.

Many applications such as autonomous vehicles and drones have strict latency requirements and demand fast inference beyond what is achievable with conventional neural networks. Another unsolved challenge is how to deal with shifts in the distributions of input and output data over time. As in all statistical learning models, the validity neural networks critically hinge on the assumption that the distribution of the input and output data does not change significantly over time. This is not the case in the real world, especially in domains such as in battlefields and cybersecurity, where fast-paced evolution of the underlying data generating mechanism is the norm. By replacing the deep neural network or RNN with a dynamical system followed by a linear classifier (light learner), reservoir computing has the potential to offer fast real-time learning and inference with potentially lower power consumption. It should be appreciated that reservoir computing generally involves utilizing a large recurrent hidden layer (called the reservoir) with fixed weights and only adjusting the output layer weights.

Accordingly, a need exists for a reservoir computing system that can readily handle shifts in the distribution of input and output data. The present disclosure fulfills that need and provides additional benefits over previous technologies.

### BRIEF SUMMARY

This disclosure describes an artificial intelligence technology for edge microsystems capable of online learning, real-time inference, and tactical response. The present disclosure is a third wave AI system which introduces a fundamentally new concept for realizing a high dimensional dynamic reservoir. In general, reservoir computing involves feeding a stream of input data into a dynamical system, which reacts and traces out a transient in its high-dimensional phase-space. This high-dimensional transient is then recorded and linearly combined to generate the desired output data.

In the Spectral Reservoir Computer described herein, data is encoded onto the optical spectrum followed by processing this data in the spectrum domain. In this approach, referred to herein as “Lambda Reservoir”, millions of lambda-nodes can be accessed in a single physical node without sacrificing speed by avoiding the need to encode the data with a high-speed temporal mask; which is the typical process utilized within existing optical reservoir computers. Thus, the Lambda nodes are the virtual nodes associated with the physical nodes of the data after it has been mapped into the new higher dimensional phase space.

The disclosed approach also eliminates the need for physical feedback, and thus significantly simplifies the necessary hardware. In addition, the mapping of data into the optical spectrum opens up the option to integrate it with photonic time stretching to capture the output of the reservoir in real-time at up to THz bandwidths for certain applications. The disclosed Lambda Reservoir approach has demonstrated its computational capability by executing standard benchmarks.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a block diagram of a spectrally-encoded nonlinear optical reservoir (Lambda-Reservoir) according to at least one embodiment of the present disclosure.

FIG. 2 is a classification diagram of a preliminary demonstration of Lambda-Reservoir computing according to at least one embodiment of the present disclosure.

FIG. 3 are plots of THz signatures captured in real-time using the Photonic Time Stretch ADC for Lambda-Reservoir computing according to at least one embodiment of the present disclosure.

FIG. 4 is a block diagram of a Lambda Reservoir with Time Stretch output for generating Fast Real-time data according to at least one embodiment of the present disclosure.

FIG. 5 is a 3D plot of simulated propagation of data-modulated spectrum of an optical pulse through a nonlinear optical medium where the nonlinearity is Self Phase Modulation (SPM) utilized according to at least one embodiment of the present disclosure.

FIG. 6 is a plot of a simulated propagation of data-modulated spectrum of an optical pulse through a nonlinear optical medium shown as a 2D heat map utilized according to at least one embodiment of the present disclosure.

FIG. 7 is a bar chart of a simulation demonstrating spoken digit recognition performed by Lambda Reservoir computing according to at least one embodiment of the present disclosure.

FIG. 8 is a block diagram of time stretch imaging for measuring cell signatures according to at least one embodiment of the present disclosure.

FIG. 9 is a plot of 1D signatures for a cell obtained from the system of FIG. 8, according to at least one embodiment of the present disclosure.

### DETAILED DESCRIPTION

### 1. Lambda-Reservoir Computing Embodiments

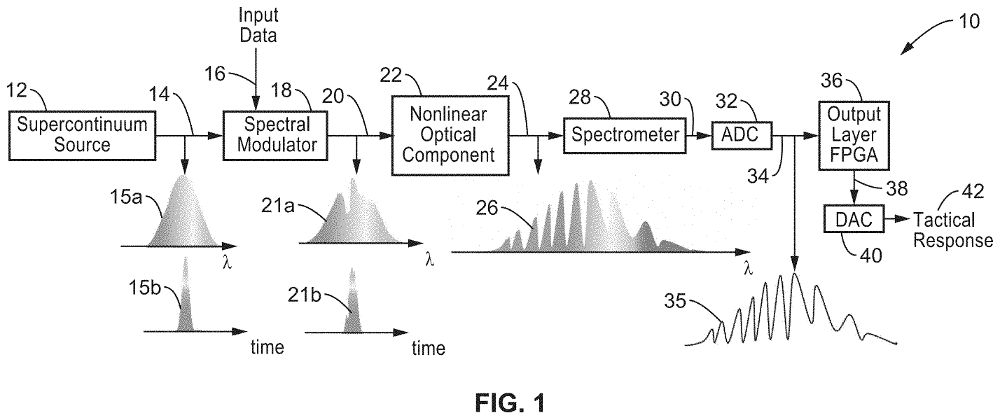

FIG. 1 illustrates an example embodiment 10 of a Spectral Reservoir Computer referred to herein as a Lambda-Reservoir Computer. It should be appreciated that Reservoir Computing is a computing paradigm that utilizes a nonlinear recurrent dynamical system to carry out information processing. The system performs nonlinear classification without the need of physical feedback. It accesses millions of wavelength nodes in a single physical node resulting in dramatic hardware reduction.

A supercontinuum source 12 generates a supercontinuum output 14 plotted with respect to wavelength (λ) 15a and time (t) 15b domains. In at least one embodiment the supercontinuum creates pulses with pulse widths on the order from 10 fs to 100 fs, thus having a bandwidth in the 100's of THz range and millions of Lambda nodes. Input data 16 is received by spectral modulator 18 which modulates data 16 onto the supercontinuum spectrum 14 to generate a modulated supercontinuum output 20 shown again with an example plot in the wavelength 21a and time 21b domains. It will be noted that modulator 18 provides a means for modulation that can be selected from different forms of optical output modulators, including spatial light modulators and temporal modulators. In a spatial light modulator the spectrum is dispersed in space using diffractive optics followed by a spatial light modulator which modulates the data onto the spectrum. In a temporal modulator the pulse spectrum is dispersed in time using group velocity dispersion in an optical fiber or a chirped fiber Bragg grating. The temporally dispersed pulse spectrum is modulated with data using an electro-optic modulator such as those using LiNbO3.

The data of the modulated supercontinuum output 20 is then processed in the spectrum (spectral) domain performed in response to nonlinear optical interactions 22. This processing with nonlinear optical interactions requires use of an optical medium with low loss and high nonlinearity. In at least one embodiment a highly nonlinear optical fiber can be utilized, for example in testing the present disclosure an optical fiber was utilized having a nonlinearity coefficient of gamma being 11 per Watt per Kilometer. It should be appreciated that various optical elements can be utilized for achieving these nonlinear optical interactions. This nonlinear optical processing results in the data being transformed to a higher dimensional space, such as in response to third order optical nonlinear phenomena. In testing of the present disclosure, the dominant phenomenon was self phase modulation (SPM). It should be noted that processing of data in the spectrum domain is performed by these nonlinear optical interactions which are modeled in at least one embodiment of the present disclosure by solving the nonlinear Schrodinger equation using the split-step Fourier method.

It should be appreciated that a nonlinear transformation of data to a higher dimensional space allows data points to be more easily separated, and thus can improve classification accuracy.

In the present disclosure all the lambda-nodes are accessed in a single physical node; because all the lambda-nodes exist in one optical pulse which is mapped into a single temporal waveform that is further detected, digitized and processed. Up to millions of lambda-nodes can be accessed in a single physical node without sacrificing complexity by avoiding the need for a large number of spatial nodes. In addition this processing can be performed without sacrificing speed by using a high-speed temporal mask. Complex interactions in a nonlinear optical medium are utilized to cause nonlinear transformation of the data with linear and nonlinear memory functionality.

In the example shown a nonlinear transformation output 24 is seen exemplified in plot 26. Then in at least one embodiment this output is shown being converted by spectrometer 28 from an optical signal to an electrical waveform 32. Optical spectrometers are often known as optical spectrum analyzers (OSAs), such as manufactured by Keysight® or Ando®.

Analog electrical waveform 30 is then converted into a digital electronic signal so that it can be digitally classified by a machine learning algorithm. The present disclosure describes utilizing an analog-to-digital converter (ADC) 32 to digitize the analog input and generate a digital envelope output 34 shown was waveform 35.

Digital envelope output 34 is then shown being received by an electronic machine learning stage as an output layer 36, shown by way of example and not limitation as an output layer field programmable logic array with output 38 converted by a digital-to-analog converter (DAC) 40 to a tactical (real-time) response 42. Various FPGA platforms can be utilized to support this machine learning stage, for example the Xilinx® Spartan 6 LX FPGA which provide up to 147K logic cell density, 4.8 Mb memory, integrated memory controllers, DSP slices, and a high performance integrated IP with support for industry standards. While even higher performance FPGA solutions are also available, such as Xilinx Kintex-7 providing nearly 30 times more memory and DSP processing, which specifically includes 500 I/O lines, 326080 logic cells, 840 DSP slices, and 16 MB of memory.

In regards to the electronic machine learning stage, it should be appreciated that a large number of machine learning mechanisms and algorithms can be used without limitation. In at least one embodiment the present disclosure has been tested using Support Vector Machine (SVM), although many other machine learning means may be utilized in the present disclosure without limitation. It should be appreciated that SVM is the most widely used classifier, and is a classifier which can be utilized with a wide range of data types. SVC achieves high accuracy with small datasets (in contrast to neural nets (NN)) which require large datasets. The objective of SVM is to find the boundary (hyperplane) between data points that best separates them by maximizing the margin. In addition it seeks to maximize the distance (margin) between the hyperplane and the nearest data points in training sets. A kernel method can be utilized for transforming datasets into a feature space so nonlinear problems can still be dealt with using this “linear” classifier. One class of common kernels involve Gaussian distance, such as using a Radius Basis Function (RBF) as a kernel.

This novel single-node reservoir computer of the present disclosure obviates the need for physical feedback and temporal masking and it is able to perform real time inference with a tactical response.

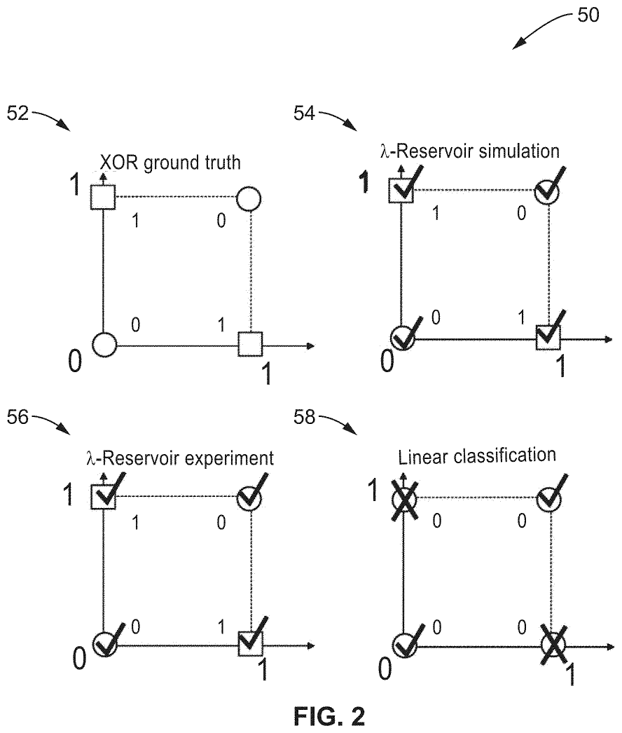

FIG. 2 illustrates a data set for an example embodiment 52, 54, 56 and 58 demonstrating a preliminary Lambda-Reservoir computing experiment according to the present disclosure. The system is able to learn nonlinear classification, including the Exclusive OR (XOR) 52 which is a nonlinear classification and a benchmark for Reservoir Computing. It should be noted that a linear classifier 58 is unable to perform the XOR operation. Thus, this preliminary experiment shows the ability of such a system to perform an XOR operation, which is a nonlinear classification problem that is a benchmark for reservoir computing.

For example using the optical reservoir technology of the present disclosure in combination with a linear classifier results in 0% error, while the same XOR test with the linear classifier alone resulted in a 50% error as is seen in FIG. 2. It is also found that the present disclosure is significantly more robust to quantization effects and to noise, for example including effects of bit length, such as bit truncation, and signal-to-noise ratio issues. For example it was found that proper results were still given by the present system across a range of quantization levels, with a range from 1 to 13 levels of quantization being tested to operate properly. In addition, proper results were still provided across a range of noise levels from 0% up to 30%.

By way of example and not limitations, other data sets tested for the present disclosure include: bright-field blood cell signatures from time stretch microscope images; feature vector signatures from phase-contrast blood cell time stretch microscope images; and spoken digits.

Successful operations of the disclosed embodiment have been demonstrated for each of the following: (1) software reservoir and classifier, including XOR, bright field cell data, TSQPI features, spoken digit (2,3,4 class); (2) software reservoir with FPGA Classifier, including bright field blood cell images; (3) hardware reservoir with software classifier, including XOR function, bright field blood cell images; and (4) hardware reservoir with FPGA Classifier, including XOR function and bright field cell images.

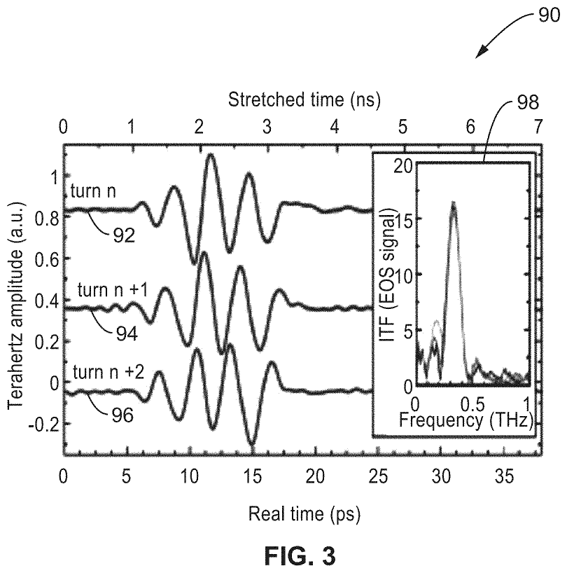

FIG. 3 illustrates an example embodiment 90 of mapping data into the spectral (spectrum) domain which opens up the option to integrate the Lambda-Reservoir with time stretch data acquisition to capture the output of the reservoir in real-time even at THz bandwidths as desired. It should be noted that the Time Stretch ADC is the only technology capable of single-shot capture of THz bandwidth signatures in real-time. In the figure plots are shown for turn n 92, turn n+1 94, and turn n+2 96, as well as a plot of inverse-trigonometric function (ITF) for the EOS signal 98. It should be noted that in FIG. 3, the real-time sampling rate was 16 TSample/s and analog bandwidth was 7 THz (single shot). It should be appreciated that the above figure is shown by way of example of a short output sequence in solving a specific problem, whereas the disclosure can solve a wide range of problems.

Another benefit of Lambda Reservoir computing is that it can be applied to Time Stretch Imaging, which combines spectral encoding plus spectrum-to-time mapping, for example serializing 2D images into a 1D time series. As a result, such architectures are naturally suitable for reservoir computing, and the disclosed Lambda Reservoir computing. Angular light scattering information has also been acquired using reservoir computing, and is applicable to the disclosed Lambda Reservoir computing.

Another unique feature of the disclosed system is its inherent ability to serialize multidimensional data into a 1D time series, making it naturally suited for reservoir computing. An example of this is the time stretch imaging system pioneered at UCLA by the Jalali-Lab, which has been used to serialize up to 5D data (2D intensity+2D phase+time). Operating Lambda-Reservoir computing in burst mode, it is capable of continuous-time operation by using a technique known as Virtual Time Gating.

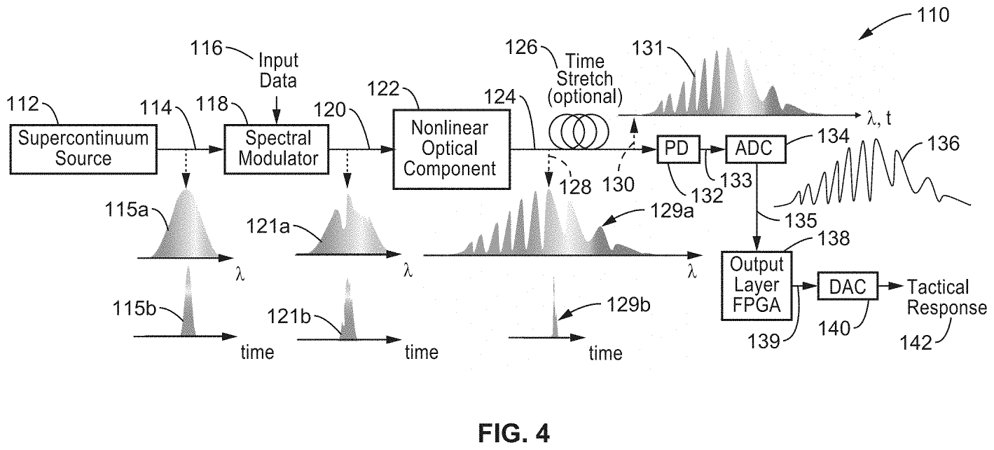

FIG. 4 illustrates an example embodiment 110 of a Lambda Reservoir with Time Stretch output for computing Fast Real-time data. This block diagram is similar to that shown in FIG. 1. A supercontinuum source 112 generates a supercontinuum output 114 plotted with respect to wavelength (λ) 115a and time (t) 115b domains. Input data 116 is received by spectral modulator 118 (e.g., spatial light modulator or temporal modulator) which provides a means for modulating data 116 onto the supercontinuum spectrum 114 to generate a modulated supercontinuum output 120 shown again with an example plot in the wavelength 121a and time 121b domains.

The data of the modulated supercontinuum output 120 is then processed in the spectrum domain performed in response to nonlinear optical interactions 122, with a nonlinear transformation output 124 seen exemplified in wavelength (λ) plot 128a and time (t) 128b domains. Processing with nonlinear optical interactions requires use of an optical medium with low loss and high nonlinearity. The dispersive element maps the spectrum into a temporal signal and slows down the temporal signal. It should be appreciated that any medium with a high ratio of group velocity dispersion to loss can be utilized. In at least one embodiment a dispersion compensating fiber (DCF) can be utilized, preferably one having a dispersion coefficient of about −100 picosecond per nanometer per Kilometer.

The above embodiment thus provides complex interactions in a nonlinear optical medium to cause nonlinear transformation of the data with linear and nonlinear memory functionality, because the nonlinear medium is also dispersive, with the memory effect being provided by the dispersion property of the nonlinear medium.

In this example embodiment, output 124 is captured using a time stretch spectrometer implemented with a dispersive optical element 126 with the optical signal 130, shown as plot 131. The optical signal is converted at a photodetector (PD) 132, or other optical to electrical detector/converter for converting optical intensity into an electrical signal output. The electrical signal output 133 is received at a digitizer exemplified as an analog-to-digital converter (ADC) 134, whose digital output 135 is received by output circuitry. In this example embodiment, the output layer preferably comprises a machine learning element, depicted by way of example and not limitation as a field-programmable logic array (FPGA) 138 programmed for this operation and outputting a digital output 139 to a digital-to-analog converter (DAC) 140 which outputs a tactical response 142.

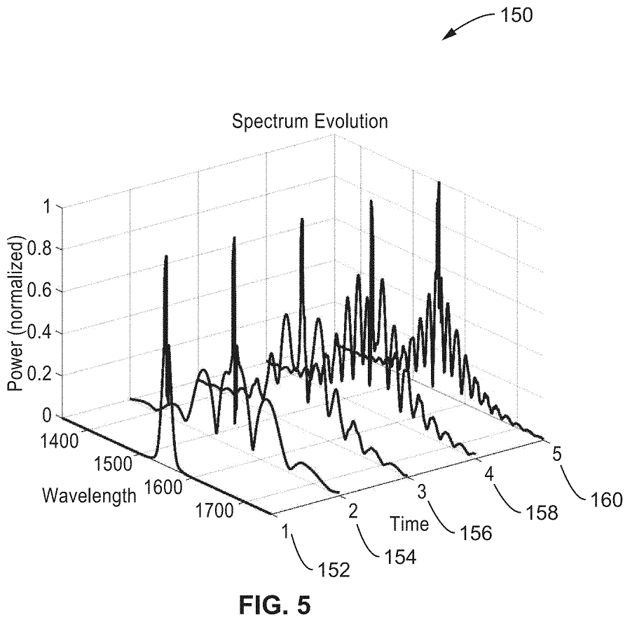

FIG. 5 illustrates an example embodiment 150 showing simulated propagation of a data-modulated spectrum of an optical pulse through a nonlinear optical medium (as depicted 22, 122 in FIG. 1 and FIG. 4) where the nonlinearity is Self Phase Modulation (SPM). Each line trace 152, 154, 156, 158 and 160 depicts the spectrum of one pulse (turn). The results clearly show the increase in the dimensionality of the data, and thus the spectral evolution.

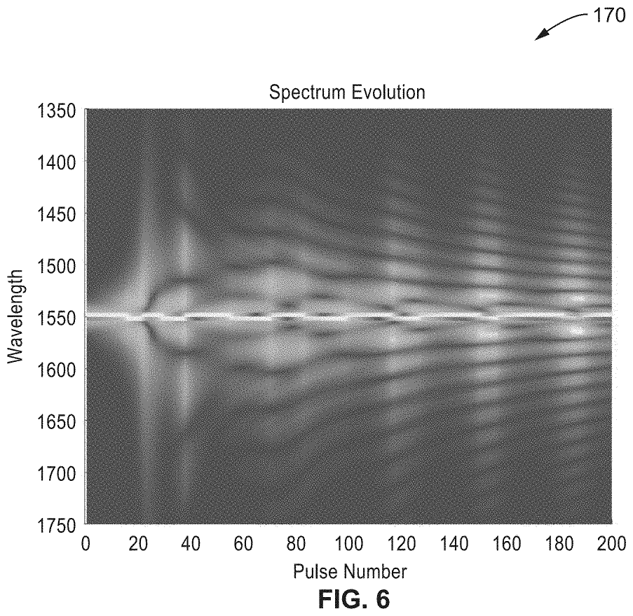

FIG. 6 illustrates an example embodiment 170, of spectral evolution that is similar to FIG. 5 showing simulated propagation of a data-modulated spectrum of an optical pulse through a nonlinear optical medium where the nonlinearity is Self Phase Modulation (SPM), but in this example the information is presented as a 2D heat map, having wavelength as the vertical axis and a horizontal axis depicting pulse numbers.

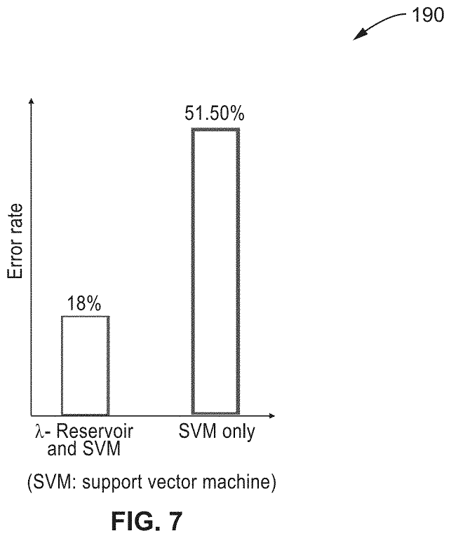

FIG. 7 illustrates an example embodiment 190 of a simulated demonstration of spoken digit recognition performed by the Lambda Reservoir computer. Nonlinear propagation was simulated by the Nonlinear Schrodinger Equation (NLSE). The addition of Lambda Reservoir is shown to significantly reduce classification error from 51.50% with support vector machine (SVM), to 18% with a combination of Lambda Reservoir computing in combination with SVM.

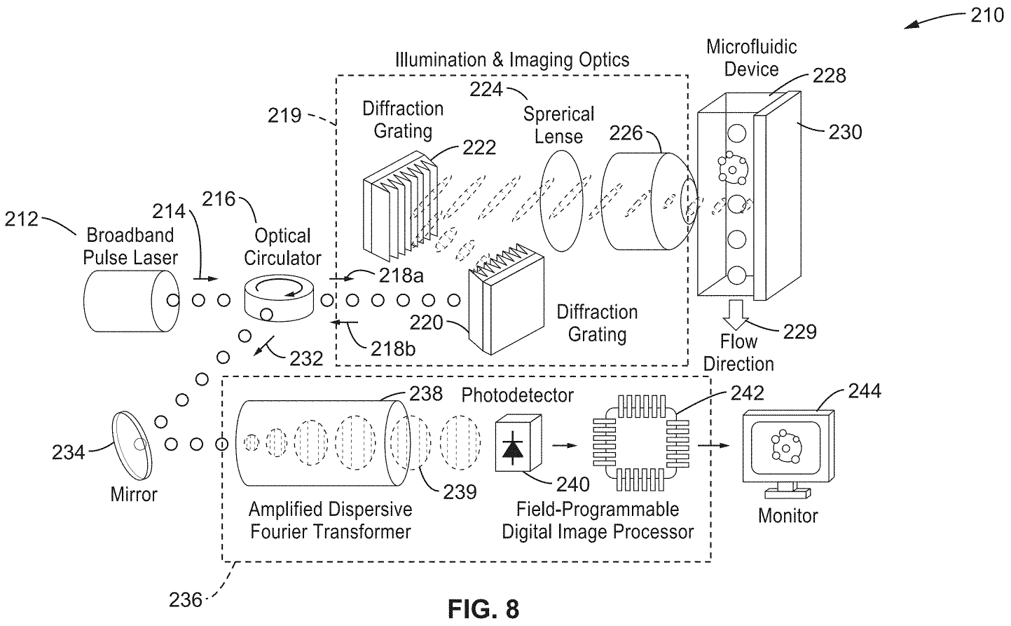

FIG. 8 illustrates an example embodiment 210 of time stretch imaging for measuring cell signatures. A broadband pulse laser 212 generates pulses 214 into optical circulator 216. Light from a first port of the optical circulator are directed into illumination and imaging optics 219 directed for imaging of a microfluidic device 228.

In particular, an example of the illumination and optics 219 is shown including multiple diffraction gratings 220, 222, which diffract and direct the diffracted light into a set of lenses, depicted by way of example as a spherical lens 224 in combination with an objective lens 226. Light is directed to a microfluidic device 228. In the example the light is directed by a reflector 230 back along the path of lenses 224, 226, and diffraction gratings 222, 220 back into optical circulator 216 which outputs this light through another port into an optical processing circuit 236. In the example shown, the light is directed through an optical device shown as mirror 234 into this optical processing section, however, it shall be appreciated that any desired optical elements may be utilized in directing the light to this optical processing circuit.

The optical processing circuit is shown with an optical device for performing amplified dispersive Fourier transformation whose output 239 is then directed to a digitizer, here exemplified simply as a photodetector 240, or other optical-to-electrical detector/converter for converting optical intensity into an electrical signal output. The electrical signal output is processed by output layer circuitry 242. In this example embodiment, the output layer circuitry preferably comprises a machine learning element, depicted by way of example and not limitation as a field-programmable digital image processor 242 and associated circuitry which outputs images, such as to a monitor 244.

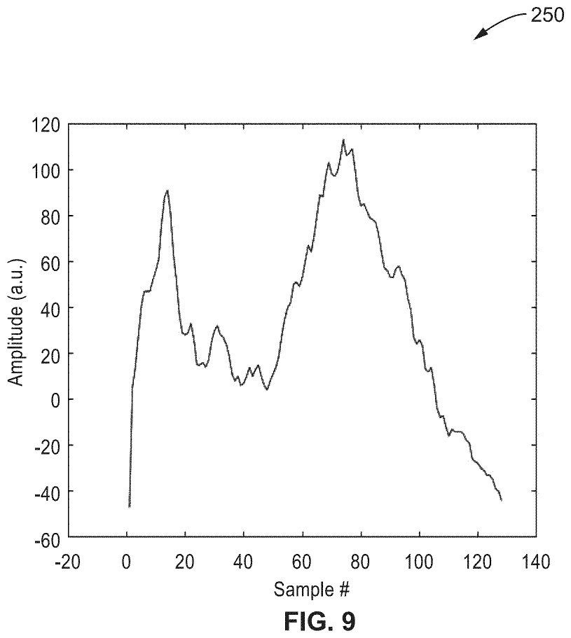

FIG. 9 illustrates an example embodiment 250 of a 1D signature of a cell, showing amplitude in arbitrary units with respect to sample number. In addition testing was performed in time stretch microscope bright field images using a software optical reservoir in combination with both FPGA linear and non-linear classifiers. In these tests it was found that the linear classifier without the reservoir reached a 93% accuracy of discerning between cancer cells and normal cells. Using a non-linear classifier without a reservoir could reach 99% accuracy. However, the present disclosure using the optical reservoir was able to achieve 99% accuracy while still using a linear classifier.

Performance was also tested using a hardware optical reservoir in combination with both FPGA linear and non-linear classifiers, and provided the same results as with the software optical reservoir. Overall it was found that using the optical reservoir according to the present disclosure reduced classification errors from 36% to 22%, under the same set of conditions. Spoken digit classification tasks were also tested to extract digits from a free spoken dataset (FSDD), using four speakers and 2000 recordings of a spoken digit range from 0 to 9. Using the optical reservoir clearly reduced classification errors across the spoken digit classes, with 2-class errors reduced from about 50% to about 7%, while 3-class errors were reduced from about 62% to about 18%, and so forth.

The present disclosure has also been validated across a range of optical reservoirs and classifiers. For example testing has validated the use of: (1) a software reservoir with a software classifier; (2) a software reservoir with an FPGA classifier; (3) a hardware reservoir with a software classifier; and (4) a hardware reservoir with a hardware classifier.

Furthermore, embodiments of the present disclosure are being developed which demonstrate spectral modulation of both high-speed temporal data as well as spatial imaging data. In addition to utilizing raw supercontinuum spectra, this development explores coding of the optical spectrum in order to enhance the Separation Property of the Lambda-Reservoir and hence the accuracy of signal classification. In at least one embodiment the present disclosure is being directed to use in for radiometric signature detection and biological imaging.

### 2. General Scope of Embodiments

The enhancements described in the presented technology can be readily implemented within various reservoir computing platforms and associated systems. It should also be appreciated that reservoir computing platforms are typically implemented to include one or more configurable electronic circuits or electronic computer processor devices (e.g., CPU, microprocessor, microcontroller, computer enabled ASIC, FPGAs, and so forth) and in some cases associated memory storing instructions (e.g., RAM, DRAM, NVRAM, FLASH, computer readable media, and so forth) whereby programming (instructions) stored in the memory are executed on the processor to perform the steps of the various process methods described herein. In addition readout mechanisms for lambda computing can comprise various optical circuits, or optical to electrical circuits, or optical to electrical to digital circuits, or combinations thereof, which feed into an electronic machine learning stage comprising any desired combination of hardware and processors.

The presented technology is non-limiting with regard to memory and computer-readable media, insofar as these are non-transitory, and thus not constituting a transitory electronic signal.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely, such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. A reservoir computer, comprising: (a) means for modulating input data onto the spectrum of a broadband optical pulse and subjecting the broadband optical pulse to nonlinear optical effects; (b) wherein said nonlinear optical effects cause the input data to be transformed to a higher dimensional space; (c) an optical spectrometer and associated electronics for converting the spectrum into a digital electronic signal; and (d) an electronic machine learning stage as an output layer for classifying input data into multiple classifications based on the higher dimensional space of the input data.

2. A reservoir computer, comprising: (a) means for modulating input data onto a spectrum of a broadband optical pulse and subjecting the broadband optical pulse to nonlinear optical effects; (b) wherein said nonlinear optical effects cause the data to be transformed to a higher dimensional space; (c) a dispersive element that maps the spectrum into a temporal signal and slows down the temporal signal; (d) a photodetector configured for converting the slowed-down temporal signal into an electrical signal; (e) an analog-to-digital converter configured for converting the electrical signal to a digital output signal; and (f) an electronic machine learning stage as an output layer which is configured for classifying input data into multiple classifications based on the higher dimensional space of the input data.

3. A reservoir computer, comprising: (a) a spectral modulator configured for modulating input data onto the spectrum of a broadband optical pulse; (b) a nonlinear optical element configured for receiving said broadband optical pulse and introducing nonlinear optical effects upon said broadband optical pulse which causes the input data to be transformed to a higher dimensional space output; (c) an optical spectrometer and digitizing circuit configured to receive said higher dimensional space output and convert its spectrum into a digital electronic signal; and (d) an electronic machine learning stage configured to receive said digital signal and to perform output layer processing, based on the higher dimensional space of the input data, on said digital signal to classify input data into a tactical response output containing multiple classifications.

4. A reservoir computer, comprising: (a) a spectral modulator configured to modulate input data onto a spectrum of a broadband optical pulse; (b) a nonlinear optical element configured for receiving said broadband optical pulse and introducing nonlinear optical effects for transforming said broadband optical pulse to a higher dimensional space output; (c) a dispersive element configured to receive the higher dimensional space output and map its spectrum into a temporal signal by slowing down and dispersing the temporal signal; (d) a photodetector configured for converting the slowed-down temporal signal into an electrical signal; (e) an analog-to-digital converter configured to convert the electrical signal into a digital signal; and (f) an electronic machine learning stage configured to receive said digital signal and to perform output layer processing, based on the higher dimensional space of the input data, on said digital signal to classify input data into a tactical response output containing multiple classifications.

5. A computer-implemented method, comprising: (a) modulating input data onto a supercontinuum spectrum; (b) processing said input data in a spectrum domain using nonlinear optical interactions; (c) wherein multiple lambda-nodes are created in the spectrum domain for each physical node of said input data; (d) using complex interactions in a nonlinear optical medium to cause nonlinear transformation of the input data with linear and nonlinear memory functionality into a higher dimensional space output; (e) converting the higher dimensional space output into a digital stream; and (f) processing the digital stream utilizing electronic machine learning to classify input data into multiple classifications based on the higher dimensional space.

6. A method performed by one or more computers, comprising: (a) modulating input data onto a supercontinuum spectrum; (b) using nonlinear optical interactions for converting said input data in a spectrum domain to a higher dimensional space output; (c) wherein multiple lambda-nodes in the spectrum domain are associated with each physical node of said input data; (d) using complex interactions in a nonlinear optical medium to cause nonlinear transformation of the input data with linear and nonlinear memory functionality; (e) converting the higher dimensional space output into a digital stream; and (f) processing the digital stream utilizing electronic machine learning to classify input data into multiple classifications based on the higher dimensional space and provide a tactical output.

7. A reservoir computer, comprising: (a) means for modulating data onto the spectrum of a broadband optical pulse and subjecting the pulse to nonlinear optical effects; (b) wherein said nonlinear optical effects cause the data to be transformed to a higher dimensional space; (c) an optical spectrometer and associated electronics for converting the spectrum into a digital electronic signal; and an electronic machine learning stage as an output layer.

8. A reservoir computer, comprising: (a) means for modulating data onto the spectrum of a broadband optical pulse and subjecting the said pulse to nonlinear optical effects; (b) wherein said nonlinear optical effects cause the data to be transformed to a higher dimensional space; (c) a dispersive element that maps the spectrum into a temporal signal and slows down the temporal signal; (d) a photodetector that converts the temporal optical signal to an electrical signal; (e) an analog to digital converter; and an electronic machine learning stage as an output layer.

9. A reservoir computer, comprising: (a) a spectral modulator configured for modulating input data onto the spectrum of a broadband optical pulse; (b) directing the modulated pulse through a nonlinear optical element configured to subject the pulse to nonlinear optical effects which cause the data to be transformed to a higher dimensional space output; (c) an optical spectrometer and digitizing circuit configured to receive said higher dimensional space output for converting the spectrum into a digital electronic signal; (d) and an electronic machine learning stage as an output layer to process the digital electronic signal.

10. A reservoir computer, comprising: (a) a spectral modulator configured for modulating input data onto the spectrum of a broadband optical pulse; (b) directing the modulated pulse through a nonlinear optical element configured to subject the pulse to nonlinear optical effects which cause the data to be transformed to a higher dimensional space output; (c) a dispersive element configured for receiving the higher dimensional space output and mapping its spectrum into a temporal signal by slowing down and dispersing the temporal signal; and (d) a photodetector that converts the temporal optical signal to an electrical signal; (e) an analog to digital converter configured for converting the electrical signal into a digital electronic circuit; and (f) an electronic machine learning stage configured for receiving said digital electronic circuit and processing it as an output layer to generate a tactical response output.

11. A computer-implemented method, comprising: (a) modulating data onto a supercontinuum spectrum; (b) processing of data in the spectrum domain performed by nonlinear optical interactions; (c) wherein lambda-nodes are accessed in a single physical node; (d) wherein complex interactions in a nonlinear optical medium are utilized to cause nonlinear transformation of the data with linear and nonlinear memory functionality; and (e) wherein said method provides a single-node reservoir computer.

12. A method performed by one or more computers, comprising: (a) modulating data onto a supercontinuum spectrum; (b) processing of data in the spectrum domain performed by nonlinear optical interactions; (c) wherein lambda-nodes are accessed in a single physical node; and (d) wherein complex interactions in a nonlinear optical medium are utilized to cause nonlinear transformation of the data with linear and nonlinear memory functionality.

13. A spectral reservoir computer, comprising: (a) means for encoding data onto the optical spectrum; and (b) means for processing of data in the spectrum domain.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing group of elements, indicates that at least one of these group elements is present, which includes any possible combination of these listed elements as applicable.

References in this specification referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

The following publications are incorporated herein by reference in their entireties.
[1] Van der Sande, Guy, Daniel Brunner, and Miguel C. Soriano. “Advances in photonic reservoir computing.” Nanophotonics 6.3 (2017): 561-576.
[2] Szwaj, Christophe, et al. “High sensitivity photonic time-stretch electro-optic sampling of terahertz pulses.” Review of Scientific Instruments 87.10 (2016): 103111.
[3] Roussel, E., et al. “Observing microscopic structures of a relativistic object using a time-stretch strategy.” Scientific reports 5 (2015): 10330.
[4] Solli, D. R., et al. “Optical rogue waves.” Nature 450.7172 (2007): 1054.
[5] Solli, D. R., C. Ropers, and B. Jalali. “Active control of rogue waves for stimulated supercontinuum generation.” Physical review letters 101.23 (2008): 233902.
[6] Solli, D. R., B. Jalali, and C. Ropers. “Seeded supercontinuum generation with optical parametric down-conversion.” Physical review letters 105.23 (2010): 233902.
[7] Herink, G., et al. “Real-time spectral interferometry probes the internal dynamics of femtosecond soliton molecules.” Science 356.6333 (2017): 50-54.
[8] Herink, G., et al. “Resolving the build-up of femtosecond mode-locking with single-shot spectroscopy at 90 MHz frame rate.” Nature Photonics 10.5 (2016): 321.
[9] Solli, D. R., et al. “Fluctuations and correlations in modulation instability.” Nature Photonics 6.7 (2012): 463.
[10] Runge, Antoine F J, Neil G R Broderick, and Miro Erkintalo. “Observation of soliton explosions in a passively mode-locked fiber laser.” Optica 2.1 (2015): 36-39.
[11] Goda, K., K. K. Tsia, and B. Jalali. “Serial time-encoded amplified imaging for real-time observation of fast dynamic phenomena.” Nature 458.7242 (2009): 1145.
[12] Goda, Keisuke, and Bahram Jalali. “Dispersive Fourier transformation for fast continuous single-shot measurements.” Nature Photonics 7.2 (2013): 102.
[13] Mahjoubfar, Ata, et al. “Time stretch and its applications.” Nature Photonics 11.6 (2017): 341.
[14] Adam, Jost, et al. “Spectrally encoded angular light scattering.” Optics express 21.23 (2013): 28960-28967.
[15] Mahjoubfar, Ata, et al. “Label-free high-throughput cell screening in flow.” Biomedical optics express 4.9 (2013): 1618-1625.
[16] Wyrwas, J. M., et al. “Linear phase-and-frequency-modulated photonic links using optical discriminators.” Optics express 20.24 (2012): 26292-26298.
[17] Rasras, Mahmoud S., et al. “Reconfigurable linear optical FM discriminator.” IEEE Photonics Technology Letters 24.20 (2012): 1856-1859.
[18] Seok, Tae Joon, et al. “64×64 Low-loss and broadband digital silicon photonic MEMS switches.” 2015 European Conference on Optical Communication (ECOC). IEEE, 2015.
[19] Seok, Tae Joon, et al. “Highly scalable digital silicon photonic MEMS switches.” Journal of Lightwave Technology 34.2 (2016): 365-371.
[20] Vaswani, Ashish, et al. “Attention is all you need.” Advances in Neural Information Processing Systems. 2017.
[21] Kung, Hsiang-Tsung. “Why systolic architectures?.” IEEE computer 15.1 (1982): 37-46.
[22] Larger, Laurent, et al. “High-speed photonic reservoir computing using a time-delay-based architecture: Million words per second classification.” Physical Review X 7.1 (2017): 011015.
[23] Sandborn, Phillip A M, et al. “Dual-sideband linear FMCW lidar with homodyne detection for application in 3D imaging.” 2016 Conference on Lasers and Electro-Optics (CLEO). IEEE, 2016.
[24] Behroozpour, Behnam, et al. “11.8 Chip-scale electro-optical 3D FMCW lidar with 8 μm ranging precision.” 2016 IEEE International Solid-State Circuits Conference (ISSCC). IEEE, 2016.
[25] Wang, Youmin, Y. Kyoungsik, and Ming C. Wu. “MEMS optical phased array for LIDAR.” The 21st microoptics conference (MOC), Berkeley, Calif., US. 2016.
[26] Behroozpour, Behnam, et al. “Lidar system architectures and circuits.” IEEE Communications Magazine 55.10 (2017): 135-142.
[27] Chen, Claire Lifan, et al. “Deep learning in label-free cell classification.” Scientific reports 6 (2016): 21471.
[28] Buckley, Brandon W., Asad M. Madni, and Bahram Jalali. “Coherent time-stretch transformation for real-time capture of wideband signals.” Optics express 21.18 (2013): 21618-21627.
[29] DeVore, Peter T S, et al. “Coherent time-stretch transform for near-field spectroscopy.” IEEE Photonics Journal 6.2 (2014): 1-7.
[30] Paquot, Yvan, et al. “Optoelectronic reservoir computing.” Scientific reports 2 (2012): 287.
[31] Han, Yan, and Bahram Jalali. “Continuous-time time-stretched analog-to-digital converter array implemented using virtual time gating.” IEEE Transactions on Circuits and Systems I: Regular Papers 52.8 (2005): 1502-1507.
[32] Valley, George C., et al. “Continuous time realization of time-stretch ADC.” 2006 International Topical Meeting on Microwave Photonics. IEEE, 2006.
[33] Dimitropoulos, Dimitris, and Bahram Jalali. “Optical information capacity of silicon.” Optical Fiber Communication Conference. Optical Society of America, 2015.

What is claimed is:

1. A reservoir computer, comprising:
means for modulating input data onto the spectrum of a broadband optical pulse and subjecting the broadband optical pulse to nonlinear optical effects;
wherein said nonlinear optical effects cause the input data to be transformed to a higher dimensional space;
an optical spectrometer and associated electronics for converting the spectrum into a digital electronic signal; and
an electronic machine learning stage as an output layer for classifying input data into multiple classifications based on the higher dimensional space of the input data.

2. A reservoir computer, comprising:
means for modulating input data onto a spectrum of a broadband optical pulse and subjecting the broadband optical pulse to nonlinear optical effects;
wherein said nonlinear optical effects cause the data to be transformed to a higher dimensional space;
a dispersive element that maps the spectrum into a temporal signal and slows down the temporal signal;
a photodetector configured for converting the slowed-down temporal signal into an electrical signal;
an analog-to-digital converter configured for converting the electrical signal to a digital output signal; and
an electronic machine learning stage as an output layer which is configured for classifying input data into multiple classifications based on the higher dimensional space of the input data.

3. A reservoir computer, comprising:
a spectral modulator configured for modulating input data onto the spectrum of a broadband optical pulse;
a nonlinear optical element configured for receiving said broadband optical pulse and introducing nonlinear optical effects upon said broadband optical pulse which causes the input data to be transformed to a higher dimensional space output;
an optical spectrometer and digitizing circuit configured to receive said higher dimensional space output and convert its spectrum into a digital electronic signal; and
an electronic machine learning stage configured to receive said digital signal and to perform output layer processing, based on the higher dimensional space of the input data, on said digital signal to classify input data into a tactical response output containing multiple classifications.

4. A reservoir computer, comprising:
a spectral modulator configured to modulate input data onto a spectrum of a broadband optical pulse;
a nonlinear optical element configured for receiving said broadband optical pulse and introducing nonlinear optical effects for transforming said broadband optical pulse to a higher dimensional space output;
a dispersive element configured to receive the higher dimensional space output and map its spectrum into a temporal signal by slowing down and dispersing the temporal signal;
a photodetector configured for converting the slowed-down temporal signal into an electrical signal;
an analog-to-digital converter configured to convert the electrical signal into a digital signal; and
an electronic machine learning stage configured to receive said digital signal and to perform output layer processing, based on the higher dimensional space of the input data, on said digital signal to classify input data into a tactical response output containing multiple classifications.

5. A computer-implemented method, comprising:
modulating input data onto a supercontinuum spectrum;
processing said input data in a spectrum domain using nonlinear optical interactions;
wherein multiple lambda-nodes are created in the spectrum domain for each physical node of said input data;
using complex interactions in a nonlinear optical medium to cause nonlinear transformation of the input data with linear and nonlinear memory functionality into a higher dimensional space output;
converting the higher dimensional space output into a digital stream; and
processing the digital stream utilizing electronic machine learning to classify input data into multiple classifications based on the higher dimensional space.

6. A method performed by one or more computers, comprising:
modulating input data onto a supercontinuum spectrum;
using nonlinear optical interactions for converting said input data in a spectrum domain to a higher dimensional space output;
wherein multiple lambda-nodes in the spectrum domain are associated with each physical node of said input data;
using complex interactions in a nonlinear optical medium to cause nonlinear transformation of the input data with linear and nonlinear memory functionality;
converting the higher dimensional space output into a digital stream; and
processing the digital stream utilizing electronic machine learning to classify input data into multiple classifications based on the higher dimensional space and provide a tactical output.
